(19) United States
(12) Patent Application Publication
(10) Pub. No.: US 2022/0100819 A1
(43) Pub. Date: Mar. 31, 2022

(54) SEARCH DEVICE, SEARCH SYSTEM, SEARCH METHOD, AND RECORDING MEDIUM

(71) Applicants: NEC CORPORATION, Tokyo (JP); NATIONAL INSTITUTE OF ADVANCED INDUSTRIAL SCIENCE AND TECHNOLOGY, Tokyo (JP)

(72) Inventors: Keiichi KISAMORI, Tokyo (JP); Yoshio KAMEDA, Tokyo (JP); Takashi WASHIO, Tokyo (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 17/424,087

(22) PCT Filed: Jan. 24, 2020
(86) PCT No.: PCT/JP2020/002608

§ 371 Date: Jul. 19, 2021

(30) Foreign Application Priority Data
Jan. 24, 2019 (JP) 2019-010663

(51) Int. Cl. G06F 17/18

(52) U.S. Cl. CPC G06F 17/18

(57) ABSTRACT

A search device includes: a relationship calculation means for calculating a relationship by using a plurality of sets, each set including a parameter value and a numerical value indicating a degree of occurrence of a target event in a case of the parameter value, the relationship being a relationship between the parameter value and the numerical value; a frequency calculation means for calculating, for a plurality of bins obtained by dividing up a range that can be taken by the numerical value, a frequency at which the numerical value is included in a bin; a number setting means for performing, for at least some bins of the plurality of bins, a setting relating to a number of the parameter value such that the lower the frequency of the bin, the greater a number of the parameter value serving as calculation subjects of the numerical value, by using the frequency; and a parameter setting means for setting parameter values by the set number.

### TECHNICAL FIELD

The present invention relates to a search device, a search system, a search method, and a recording medium.

### BACKGROUND ART

Rare events such as stray light (ghosts) occurring in a telescope mounted in an artificial satellite have a high risk of being overlooked, and it is thus desired that they can be searched for efficiently. Therefore, Non-Patent Document 1 proposes a method for efficiently searching for a condition for a rare event to occur by using a method called multicanonical-MCMC (Markov Chain Monte Carlo).

### PRIOR ART DOCUMENTS

### Non-Patent Documents

[Non-Patent Document 1] “A Rare and Critical Condition Search technique and its Application to Telescope Stray Light Analysis”, Kisamori and 3 others, SIAM, 2018

### SUMMARY OF THE INVENTION

### Problem to be Solved by the Invention

In the method disclosed in Non-Patent Document 1, a probability distribution for parameter value sampling corresponding to the condition of an event occurrence is given, and sampling is performed according to the probability distribution to thereby efficiently search for the condition for a rare event to occur. When the probability distribution for parameter value sampling is not specified, the user that searches for an event occurrence condition using the method disclosed in Non-Patent Document 1 needs to set the probability distribution for parameter value sampling. The search efficiency of an occurrence condition of a rare event by the method disclosed in Non-Patent Document 1 is dependent on parameter value sampling. Therefore, it is preferable that the user appropriately set the probability distribution for parameter value sampling, using background knowledge and so forth, and this becomes a burden on the user.

It is preferable that a device that searches for a condition for a target event (an event serving as a target of an occurrence condition) to occur be capable of efficiently searching for a situation where the target event occurs, even when the information that serves as a key to the search such as the probability distribution for parameter value sampling is not obtained in advance.

An example object of the present invention is to provide a search device, a search system, a search method, and a recording medium capable of solving the problems mentioned above.

### Means for Solving the Problem

According to a first example aspect of the present invention, a search device includes: a relationship calculation means for calculating a relationship by using a plurality of sets, each set including a parameter value and a numerical value indicating a degree of occurrence of a target event in a case of the parameter value, the relationship being a relationship between the parameter value and the numerical value; a frequency calculation means for calculating, for a plurality of sections obtained by dividing up a range that can be taken by the numerical value, a frequency at which the numerical value is included in a section; a number setting means for performing, for at least some sections of the plurality of sections, a setting relating to a number of the parameter value such that the lower the frequency of the section, the greater a number of the parameter value serving as calculation subjects of the numerical value, by using the frequency; and a parameter setting means for setting parameter values by the set number.

According to a second example aspect of the present invention, a search method executed by a computer includes: calculating a relationship by using a plurality of sets, each set including a parameter value and a numerical value indicating a degree of occurrence of a target event in a case of the parameter value, the relationship being a relationship between the parameter value and the numerical value; calculating, for a plurality of sections obtained by dividing up a range that can be taken by the numerical value, a frequency at which the numerical value is included in a section; performing, for at least some sections of the plurality of sections, a setting relating to a number of the parameter value such that the lower the frequency of the section, the greater a number of the parameter value serving as calculation subjects of the numerical value, by using the frequency; and setting parameter values by the set number.

According to a third example aspect of the present invention, a recording medium stores a search program that causes a computer to execute: calculating a relationship by using a plurality of sets, each set including a parameter value and a numerical value indicating a degree of occurrence of a target event in a case of the parameter value, the relationship being a relationship between the parameter value and the numerical value; calculating, for a plurality of sections obtained by dividing up a range that can be taken by the numerical value, a frequency at which the numerical value is included in a section; performing, for at least some sections of the plurality of sections, a setting relating to a number of the parameter value such that the lower the frequency of the section, the greater a number of the parameter value serving as calculation subjects of the numerical value, by using the frequency; and setting parameter values by the set number.

### Effect of the Invention

According to an example embodiment of the present invention, it is possible to efficiently search for a situation where a target event occurs even when the information that serves as a key to the search is not obtained in advance.

### BRIEF DESCRIPTION OF THE DRAWINGS

FIG. 1 is a schematic block diagram showing a functional configuration of a search device according to an example embodiment.

FIG. 2 is a diagram showing an example of a model to illustrate a relationship between a parameter value set by a distribution determination unit according to the example embodiment and a numerical value indicating the degree of the occurrence of a target event in the case of the parameter value.

FIG. 3 is a diagram showing an example of parameter value sampling on the basis of an energy function, performed by a condition acquisition unit according to the example embodiment.

FIG. 4 is a diagram showing an example of the initial setting of an energy function by a distribution determination unit in a case where there are two parameters of a model according to the example embodiment.

FIG. 5 is a diagram showing an example in which the distribution determination unit according to the example embodiment has updated the energy function from the initial setting shown as an example in FIG. 4.

FIG. 6 is a diagram showing an example in which the distribution determination unit according to the example embodiment has further updated the energy function from the initial setting shown as an example in FIG. 5.

FIG. 7 is a diagram showing an example in which the distribution determination unit according to the example embodiment has further updated the energy function from the setting shown with the graph G61 in FIG. 6.

FIG. 8 is a diagram showing an example of sampling of the value of a parameter X performed on the basis of the energy function by a condition acquisition unit according to the example embodiment.

FIG. 9 is a diagram conceptually showing an example of weight coefficient values calculated by a coefficient setting unit according to the example embodiment.

FIG. 10 is a diagram showing an example of weight coefficient values calculated by the coefficient setting unit according to the example embodiment.

FIG. 11 is a diagram showing a first example of parameter values temporarily sampled by a sampling processing unit according to the example embodiment.

FIG. 12 is a diagram showing a second example of parameter values temporarily sampled by the sampling processing unit according to the example embodiment.

FIG. 13 is a flowchart showing an example of a processing procedure in which the search device according to the example embodiment searches for an occurrence condition of a target event.

FIG. 14 is a flowchart showing an example of a processing procedure in which the condition acquisition unit according to the example embodiment samples the value of the parameter X on the basis of the energy function.

FIG. 15 is a flowchart showing an example of a processing procedure in which the coefficient setting unit according to the example embodiment calculates a weight coefficient value of the value of the energy function for each section.

FIG. 16 is a diagram showing a configuration example of a search system in a case where a device different from the search device performs computation of a model.

FIG. 17 is a diagram showing an example of a configuration of an event occurrence search device according to an example embodiment.

### EXAMPLE EMBODIMENT

Hereinafter, example embodiments of the present invention are described; however, the present invention within the scope of the claims is not limited by the following example embodiments. Furthermore, all the combinations of features described in the example embodiment may not be essential for the solving means of the invention.

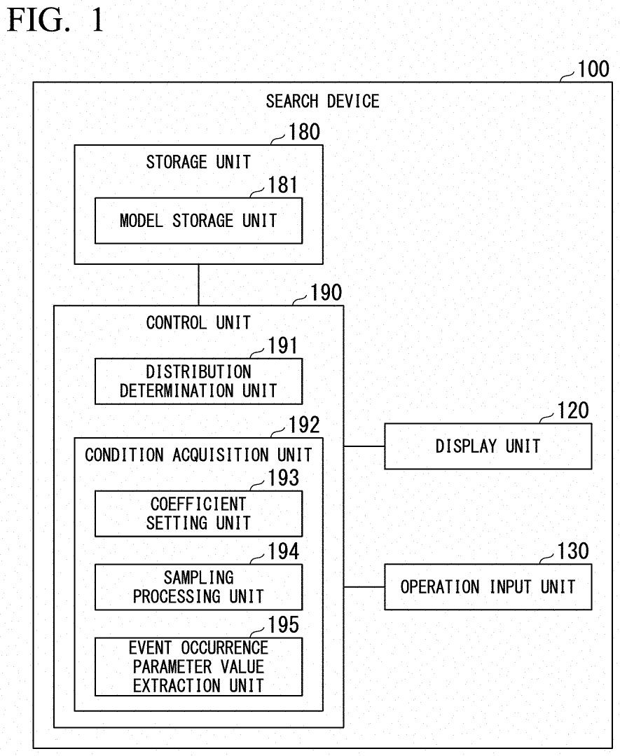

FIG. 1 is a schematic block diagram showing a functional configuration of a search device according to an example embodiment. As shown in FIG. 1, the search device 100 includes a display unit 120, an operation input unit 130, a storage unit 180, and a control unit 190. The storage unit 180 includes a model storage unit 181. The control unit 190 includes a distribution determination unit 191 and a condition acquisition unit 192. The condition acquisition unit 192 includes a coefficient setting unit 193, a sampling processing unit 194, and an event occurrence parameter value extraction unit 195.

The search device 100 acquires a plurality of sets that each combine a parameter value, and information indicating whether or not a target event occurs in the case of the parameter value. The target event referred to here is an event serving as a target for which the search device 100 searches for a condition for that event to occur. The parameter value indicates a target condition (situation) for determining whether or not the target event occurs.

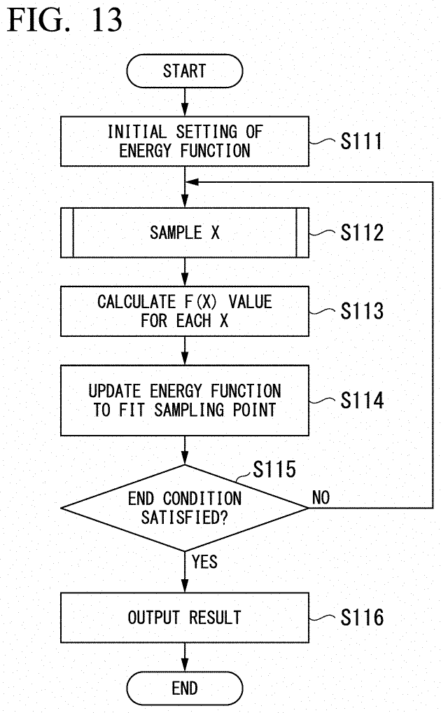

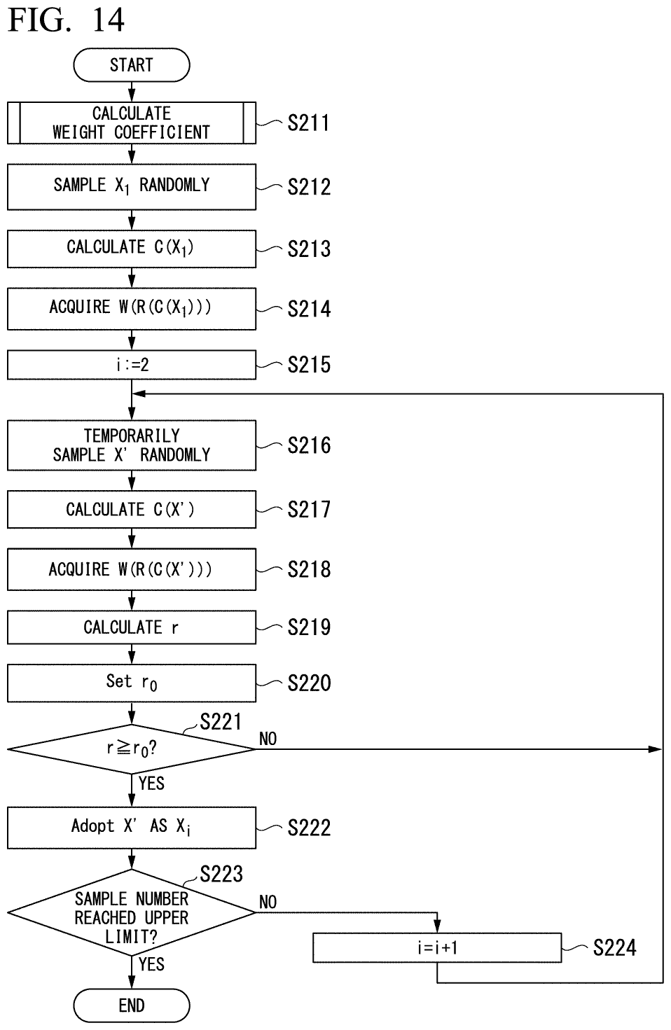

The search device 100 may acquire a plurality of sets that each combine a parameter value, and numerical value information indicating the degree of the occurrence of the target event in the case of that parameter value. The search device 100 searches for a situation in which a target event occurs (a condition, hereinafter referred to as “occurrence condition”), by executing a process as described later with reference to FIG. 13, FIG. 14, and so forth. The numerical information is, for example, information indicating the degree of similarity between an event that occurs and the target event that is the search target. The search device 100 may acquire information indicating an event and calculate the degree of similarity between the acquired event and the target event.

The event that occurs in the case of a parameter value is calculated, for example, by acquiring the parameter value and executing a process according to a certain simulation model on the basis of the parameter value. The event that occurs in the case of a parameter value may be, for example, an event that is actually obtained by conducting an experiment, measurement, observation, or the like in the situation indicated by the parameter value.

The simulation model receives input of a parameter value and outputs an event (a result) that occurs in the case of the parameter value. However, the simulation model may be a model on which an inverse computation cannot be performed, that is, one that cannot receive input of an event (a result) and output a parameter value (a situation) as a result thereof. In order to search for the occurrence condition of a target event, the search device 100 repeats the process of generating a parameter value and confirming whether or not the target event occurs in the case of the generated parameter value (situation).

The search device 100 searches for an event occurrence condition (a condition in which an event occurs) by using a model that receives an input of a parameter value and outputs a value indicating whether or not an event occurs. The model used by the search device 100 may be a model that outputs a result upon receiving input of a parameter value, but cannot perform inverse computation, that is, one that cannot receive input of a result and output a parameter value as a result thereof. In order to search for the occurrence condition of an event without using inverse computation, the search device 100 repeats the process of sampling a parameter value and inputting the sampled parameter value into the model to confirm whether or not the event occurs.

The sampling referred to here is to set a target parameter value for checking whether or not a target event occurs. In particular, the sampling referred to here is not limited to selecting any of the given values. The search device 100 may newly generate (for example, calculate) a parameter value.

In each example embodiment of the present application, sampling may be either a process of selecting from a plurality of parameter values stored in a database, or a process of calculating a parameter value on the basis of a numerical value indicating the degree of occurrence of a target event and a relationship.

When searching for the occurrence condition of an event that occurs rarely, an immense amount of time may be required for generating a large number of parameter values indicating conditions (situations), and for confirming whether or not target events occurs under conditions indicated by those parameter values. In order to efficiently search for a parameter value at which a target event occurs, the search device 100 executes processes described in detail later with reference to FIG. 13 to FIG. 15 to thereby search for a parameter value at which the target event of the occurrence condition search occurs.

As described above, the event that occurs in the case of a parameter value is calculated, by executing a process according to a certain simulation model on the basis of the parameter value. The event that occurs in the case of a parameter value may be, for example, an event that is actually obtained by conducting an experiment, measurement, observation, or the like in the situation indicated by the parameter value. Therefore, a parameter value in the case where the target event occurs indicates a situation (condition) in which the target event occurs.

The search device 100 is configured, using a computer (an information processing device, or a calculation device) such as a personal computer (PC) and a workstation.

The display unit 120 includes a display screen such as a liquid crystal panel or an LED (light emitting diode) panel, and displays various types of images. For example, the display unit 120 displays search results by the search device 100.

The operation input unit 130 includes input devices such as a keyboard and a mouse, and receives user operations. For example, the operation input unit 130 receives a user operation instructing the start of a search for an occurrence condition (a condition in which a target event occurs).

The storage unit 180 stores various types of data. The storage unit 180 is configured using a storage device included in the search device 100.

The model storage unit 181 is capable of storing, for example, a model that indicates the relationship between a parameter value and a numerical value indicating the degree of the occurrence of a target event in the case of the parameter value. The model storage unit 181 may store, for example, a model that indicates the relationship between a parameter value and information indicating whether or not a target event occurs in the case of the parameter value. The information indicating whether or not a target event occurs may be two values of information indicating, for example, that a target event occurs or that a target event does not occur.

The control unit 190 controls each unit of the search device 100 and executes various processes. The control unit 190 is configured by a CPU (Central Processing Unit), included in the search device 100, reading out a program from the storage unit 180 and executing the program.

The distribution determination unit 191 determines the sampling distribution of parameter values input to the model stored in the model storage unit 181. Then, the distribution determination unit 191 updates the distribution on the basis of the output of the model with respect to the input of the sampled parameter values.

In other words, the distribution determination unit 191 calculates, in relation to a plurality of input sets, a distribution that indicates the relationship between a parameter value and a numerical value indicating the degree of the occurrence of a target event in the case of the parameter value. The distribution determination unit 191 obtains for example, the relationship between a parameter value and a numerical value in the case of the parameter value, in accordance with model fitting that approximates using a hypersurface.

Thereby, the search device 100 calculates parameter values according to numerical values, on the basis of this distribution.

The condition acquisition unit 192 samples parameter values on the basis of the distribution determined by the distribution determination unit 191, and acquires an occurrence condition of an event on the basis of the output of the model with respect to the input of the sampled parameter values.

The coefficient setting unit 193 sets a coefficient value (weight coefficient value) for performing sampling in accordance with the distribution indicated by the hypersurface.

The sampling processing unit 194 performs sampling in accordance with the distribution indicated by the hypersurface, using the weight coefficient value set by the coefficient setting unit 193. Specifically, the sampling processing unit 194 performs temporary sampling of parameter values. The sampling processing unit 194 determines, for each of the temporarily sampled parameter values, whether or not to adopt it as sampling of the parameter value, using the weight coefficient value set by the coefficient setting unit 193.

The event occurrence parameter value extraction unit 195 extracts, among the parameter values adopted as a sampling, parameter values that have been input to the model and are considered to have the occurrence of a target event. The parameter value extracted by the event occurrence parameter value extraction unit 195 indicates a condition under which a target event occurs.

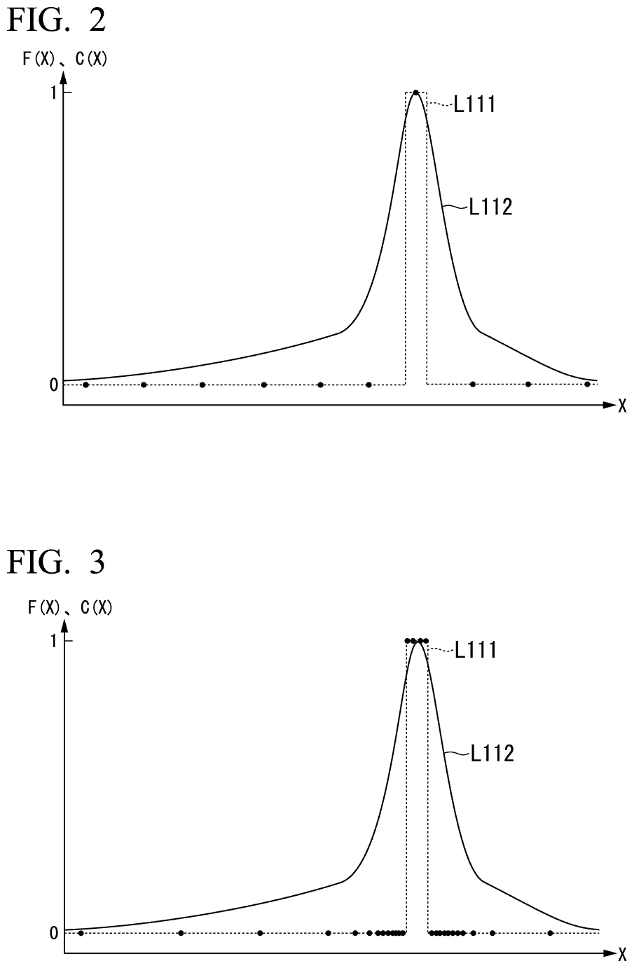

FIG. 2 is a diagram showing an example of a model to illustrate a relationship between a parameter value set by the distribution determination unit 191 and a numerical value indicating the degree of the occurrence of a target event in the case of the parameter value. The horizontal axis of the graph in FIG. 2 shows parameter values. The vertical axis indicates numerical values. The numerical value takes 1 when a target event occurs. The numerical value takes 0 when a target event does not occur. When the numerical value is an intermediate value between 1 and 0, the closer the numerical value is to 1, the higher the degree of occurrence of the target event, and the closer the numerical value is to 0, the lower the degree of occurrence of the target event.

The line L111 indicates a model in the case where the numerical values are two values. In this model, the numerical values may be three or more values, and may be continuous as shown by the line L112. In FIG. 2, for convenience of explanation, the parameter is assumed to be one parameter indicated by X.

Hereunder, the model parameters (input parameters) are indicated by X. The number of model parameters in the model may be plural. Therefore, the parameter X may be represented by a vector as in Equation (1).

$$\begin{matrix}[ Equation 1 ] & \\ X = ( {x}_{1} , {x}_{2} , ⋯ , {x}_{n} ) & ( 1 )\end{matrix}$$

In Equation (1), n is a positive integer indicating the number of model parameters.

A model that outputs a value indicating whether or not a target event occurs (or a numerical value indicating the degree of occurrence of a target event) in response to the input of the value of the parameter X is indicated by F(X). When the model F(X) outputs a value indicating whether or not a target event occurs, the model F(X) is a binary function that takes a value of either 0 or 1. The value “0” of the model F(X) indicates that a target event does not occur. The value “1” of the model F(X) indicates that a target event does occur.

A function that is set by the distribution determination unit 191 and that indicates a hypersurface that approximates the relationship between the parameter value input to the model and the output of the model, is referred to as an energy function, and is indicated by C(X).

The distribution determination unit 191 corresponds to an example of a relationship calculation unit. The energy function corresponds to an example of information showing the relationship between a parameter value and a numerical value indicating the degree of the occurrence of a target event in the case of the parameter value.

Moreover, it can be said that the energy function indicates the degree to which a target event occurs. It can be said that the distribution determination unit 191 calculates the degree to which a target event occurs by calculating the energy function.

In the example of FIG. 2, the model F(X) is shown by the line L111. The energy function C(X) is shown by the line L112.

The distribution determination unit 191 sets the energy function C(X) so as to approximate a plurality of sampling points obtained by inputting the value of the parameter X into the model F(X) with a hypersurface. As a method for the distribution determination unit 191 to obtain the energy function C(X) for a plurality of sets of a parameter value and a numerical value indicating the degree of the occurrence of a target event in the case of the parameter value, for example, the least squares method may be used; however, it is not limited to this method.

The setting method in which the distribution determination unit 191 sets the energy function C(X) is not limited to a specific method. The energy function C(X) may be described using, for example, a radial basis function. In such a case, a process of obtaining the energy function C(X) may be achieved by a process of adjusting the weight coefficient value of each of the plurality of the distribution functions.

The purpose of the distribution determination unit 191 obtaining the energy function C(X) is to perform sampling in accordance with a probability density that takes a greater value in the vicinity of the numerical value at which a target event occurs and that has a foot including a boundary for whether or not a target event has occurred, as shown in the example of FIG. 2.

FIG. 3 is a diagram showing an example of parameter value sampling on the basis of an energy function, performed by the condition acquisition unit 192. The horizontal axis of the graph shown in FIG. 3 indicates parameter values, and the vertical axis indicates values of the model F(X) (output values) and values of the energy function C(X) (values indicated by the hypersurface).

As with the case of FIG. 2, the line L111 shows an example of the model F(X). The line L112 shows an example of the energy function C(X).

The dots on the line L111 show an example of the output value of the model F(X) with respect to the value of the parameter X sampled by the condition acquisition unit 192 on the basis of the energy function C(X) of the line L111.

In the example of FIG. 3, the energy function C(X) takes a greater value in the vicinity of the parameter value at which a target event occurs and has a foot including a boundary for whether or not a target event has occurred. By performing sampling on the basis of the energy function C(X), the condition acquisition unit 192 can perform more samplings in a region where a target event occurs and a region including a boundary for whether or not the target event occurs, compared to other regions. As a result, the following two effects can be obtained.

(1) The Range of Conditions Under which a Target Event Occurs can be Grasped.

The condition acquisition unit 192 can identify the position of the boundary by performing a comparatively large number of samplings in the vicinity of the boundary that determines whether or not a target event occurs. Therefore, it is expected that the conditions (situations) in which a target event occurs can be grasped on the basis of the position of the boundary.

Identifying the position of this boundary and grasping the range of the occurrence of a target event can be made efficient by the distribution determination unit 191 setting the energy function C(X) having an appropriate spread.

If the foot of the energy function C(X) is too narrow, the value of the energy function C(X) sharply decreases in the vicinity of the boundary. As a result, the number of parameter value samplings performed by the condition acquisition unit 192 decreases in the vicinity of the boundary. As a result, the parameter values calculated by the condition acquisition unit 192 are concentrated around the parameter value at which a target event occurs, and the search for the condition where the target event occurs becomes inefficient. In particular, the search for the boundary between the condition where the target event occurs and the condition where the target event does not occur becomes inefficient.

On the other hand, when the foot of the energy function C(X) is too wide, the value of the energy function C(X) is high not only in the region where the target event occurs but also in the region where the target event does not occur. In this case, it is considered that the number of samplings in the vicinity of the boundary for whether or not the target event occurs becomes comparatively small, and the distribution determination unit 191 cannot efficiently identify the position of the boundary.

As a result of the distribution determination unit 191 repeatedly updating the energy function C(X), it is expected that the number of samplings in the vicinity of the parameter value at which the target event occurs will increase, and the energy function C(X) updated on the basis of sampling data will be updated to an appropriate function.

(2) Possibility of Further Detecting Conditions where a Target Event Occurs is Comparatively High.

When a parameter value where a target event occurs is detected, the parameter value in the vicinity of the parameter value is considered to indicate a condition comparatively similar to the parameter value at which the target event occurs. In this respect, when the detected parameter value is the parameter value in the vicinity, the target event is comparatively likely to occur. Therefore, the search device 100 searching the vicinity of the parameter value at which the target event occurs makes the possibility of further detecting the parameter value at which the target event occurs comparatively high.

Normally, it is difficult for the search device 100 to directly see the distribution of the output of the model F(X) as illustrated by the line L111 in FIG. 3. Therefore, it is difficult for the distribution determination unit 191 to set an appropriate energy function C(X) at the start of the search. Thus, the distribution determination unit 191 temporarily sets the energy function C(X) in the initial setting, and repeatedly updates the energy function C(X) according to the processing described later with reference to FIG. 13 to FIG. 15.

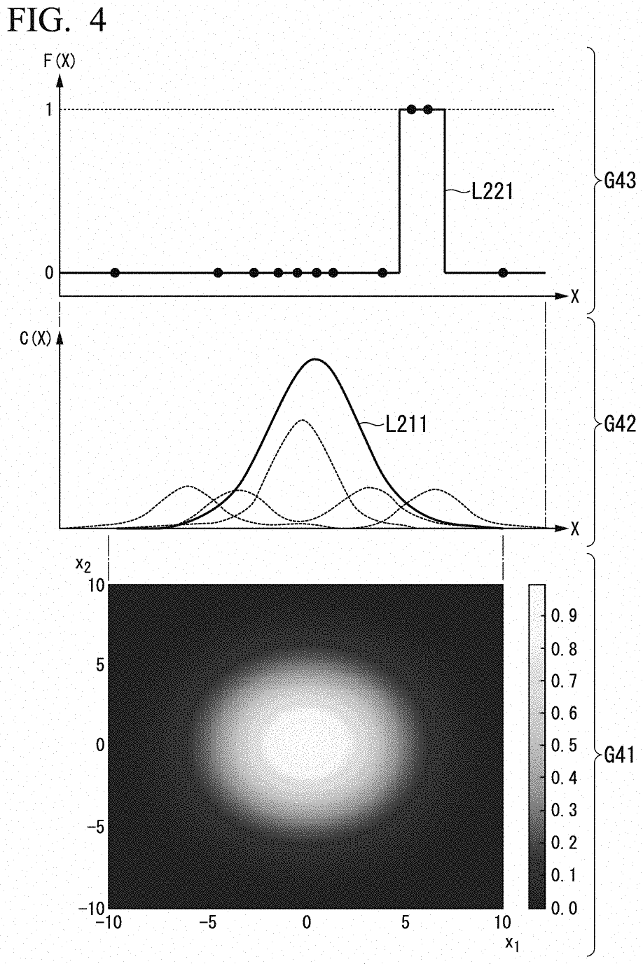

FIG. 4 is a diagram showing an example of the initial setting of an energy function by the distribution determination unit 191 in a case where there the model F(X) has two parameters. FIG. 4 shows three graphs, G41, G42, and G43. Of these, the graphs G41 and G42 show an example of the initially set energy function C(X). The horizontal axis of the graph G41 shows the value of parameter x₁, and the vertical axis shows the value of parameter x₂. The graph G41 shows an example of a case where the value of the parameter X is represented by the two-dimensional axes of x₁ and x₂, and the value of the energy function C(X) is shown in brightness (black-white gradation).

On the other hand, the horizontal axis of the graph G42 shows the value of parameter X, and the vertical axis shows the value of the energy function C(X) (that is, the degree of the occurrence of a target event). The line L211 shows the energy function C(X). In the graph G42, the value of the parameter X is represented by a one-dimensional axis for the sake of explanation. Specifically, the graph G42 shows a diagram in which x₁ is projected along the x₂ axis in the graph G41.

In the initial setting of the energy function C(X), the distribution determination unit 191 may set the energy function C(X) to a predetermined function.

The graph G43 shows an example of the output value of the model F(X) with respect to the value of the parameter X sampled by the condition acquisition unit 192 on the basis of the energy function C(X) shown in the graph G42. As described above, the output value of model F(X) indicates whether or not a target event occurs. The horizontal axis of the graph G43 shows the value of parameter X, and the vertical axis shows the value of the model F(X). The line L221 shows the model F(X). The dots on the line L221 show an example of the relationship between the value of the parameter X sampled by the condition acquisition unit 192 on the basis of the energy function C(X) and the output value of the model F(X) with respect to the parameter X. Comparing the vicinity of the peak of the energy function C(X) with the region other than the peak, in the example shown in FIG. 4, the number of parameter values is larger near the peak. On the other hand, generated parameter values when a target event occurs (dots where F(X)=1) are only two. Moreover, the parameter value when the target event occurs is biased to the side where the parameter value is small (to the left side when facing FIG. 4) in the region where “F(X)=1”.

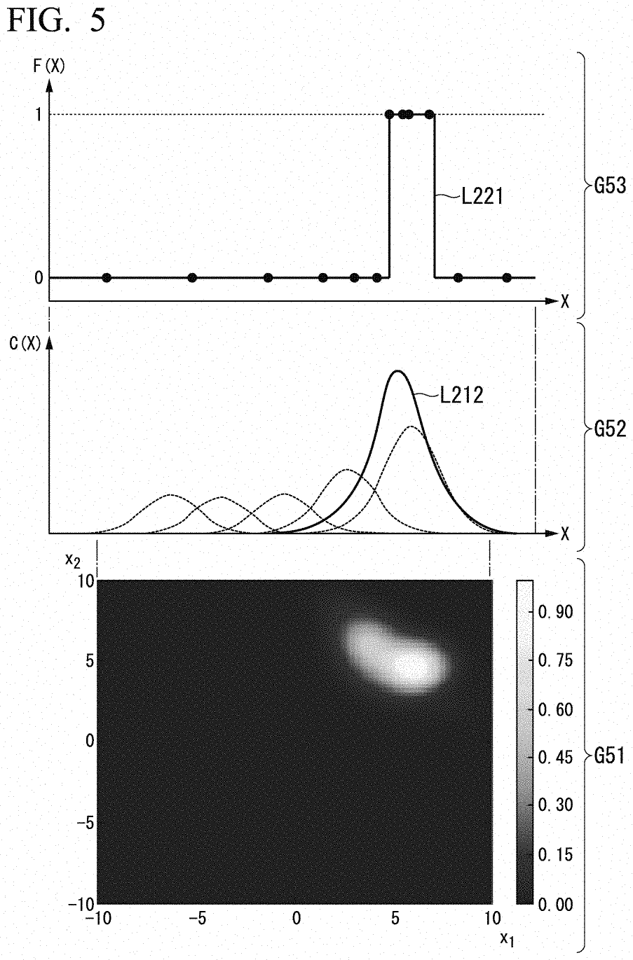

FIG. 5 is a diagram showing an example in which the distribution determination unit 191 has updated the energy function from the initial setting shown as an example in FIG. 4. The distribution determination unit 191 updates the energy function on the basis of a numerical value indicating the degree of the occurrence of a target event in the case of the parameter value selected in the initial setting (or information indicating whether or not the target event occurs). That is to say, the distribution determination unit 191 updates the energy function by calculating the energy function on the basis of a plurality of sets. In the plurality of sets, the parameter value selected by the distribution determination unit 191 in the initial setting and the numerical value indicating the degree of the occurrence of the target event in the case of the parameter value, are combined.

FIG. 5 shows three graphs, G51, G52, and G53. Of these, the graphs G51 and G52 show an example of the energy function C(X) that has been updated from the initial setting (graphs G41 and G42). The horizontal axis of the graph G51 shows the value of parameter x₁, and the vertical axis shows the value of parameter x₂. The graph G51 shows an example of a case where the value of the parameter X is represented by the two-dimensional axes of x₁ and x₂, and the value of the energy function C(X) is shown in brightness (black-white gradation).

On the other hand, the horizontal axis of the graph G52 shows the value of parameter X, and the vertical axis shows the value of the energy function C(X). The line L212 shows the energy function C(X). In the graph G52, the value of the parameter X is represented by a one-dimensional axis for the sake of explanation. Specifically, the graph G52 shows a diagram in which x₁ is projected along the x₂ axis in the graph G51.

In the graph G43 of FIG. 4, the value of the parameter X at which the target event occurs (that is to say, the value of X where “F(X)=1”) is detected on the right side of the figure. Accordingly, as shown by the line L212 of the graph G52, the peak (the local maximum point) of the energy function C(X) shifts to the right side in the figure, of the peak of the energy function C(X) shown by the line L211 of the graph G42 of FIG. 4. This corresponds to the distribution determination unit 191 calculating the energy function in which the peak of the energy function C(X) shifts to the right side in the figure, of the peak of the graph G41 in FIG. 4, in the graph G51.

This shift of the peak of the energy function arises as a result of the distribution determination unit 191 re-generating the energy function C(X) of the graph G51 so as to fit the plurality of sets (the sets of a parameter value and a numerical value indicating the degree of the occurrence of a target event in the case of the parameter value) obtained on the basis of the energy function C(X) of the graph G41.

The graph G53 shows an example of the output value of the model F(X) (that is, information indicating whether or not a target event occurs) with respect to the value of the parameter X sampled by the condition acquisition unit 192 on the basis of the energy function C(X) shown in the graph G52. The horizontal axis of the graph G53 shows the value of parameter X, and the vertical axis shows the value of the model F(X). The line L221 shows the model F(X) that is the same as that in the case of the graph G43. Since the line L221 is the same line according to the same model as that in the case of the graph G43, the same reference symbol (L221) as that in the case of the graph G43 is used. The dots on the line L221 show an example of the output value of the model F(X) with respect to the value of the parameter X sampled by the condition acquisition unit 192 on the basis of the energy function C(X) of the line L211.

In the graph G43 of FIG. 4, the number of sampling points of the value of the parameter X at which a target event occurs was two. In contrast to this, since the peak of the energy function C(X) has shifted to the right side, in the graph G53, the sampling points of the value of the parameter X at which a target event occurs have increased to four. In other words, by calculating the parameter value according to the energy function C(X), the frequency of the occurrence of the target event in the case of the parameter value has increased as compared with the case of FIG. 4.

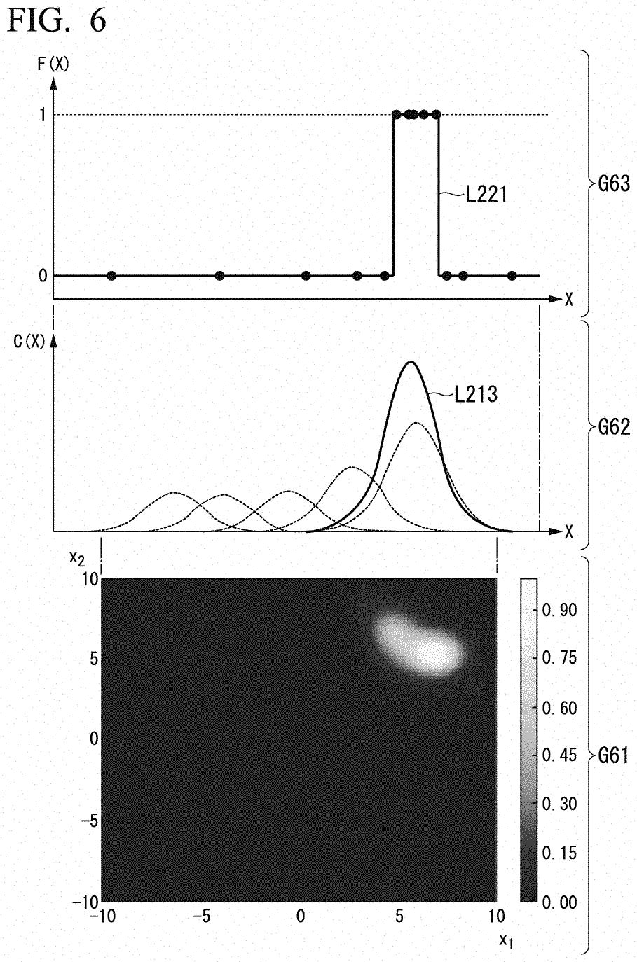

FIG. 6 is a diagram showing an example in which the distribution determination unit 191 has further updated the energy function from the setting shown in FIG. 5. FIG. 6 shows three graphs, G61, G62, and G63. Of these, the graphs G61 and G62 show an example of the energy function C(X) that has been updated from the setting (graphs G51 and G52) shown in FIG. 5. The horizontal axis of the graph G61 shows the value of parameter x₁, and the vertical axis shows the value of parameter x₂. The graph G61 shows an example of a case where the value of the parameter X is represented by the two-dimensional axes of x₁ and x₂, and the value of the energy function C(X) is shown in brightness (black-white gradation).

On the other hand, the horizontal axis of the graph G62 shows the value of parameter X, and the vertical axis shows the value of the energy function C(X). The line L213 shows the energy function C(X). In the graph G62, the value of the parameter X is represented by a one-dimensional axis for the sake of description. Specifically, the graph G62 shows a diagram in which x₁ is projected along the x₂ axis in the graph G61.

As described above, in the graph G53 of FIG. 5, the number of values of the parameter X at which the target event occurs (that is to say, the value of X where F(X)=1) has increased from the case of the graph G43. Moreover, in the graph G43, the value of the parameter X where the target event occurs is biased to the side where the parameter value is small in the region where “F(X)=1”. On the other hand, the graph G53 also shows the value of the parameter X where the target event occurs, on the side where the parameter value is large. Accordingly, as shown by the line L213 of the graph G62, the distribution determination unit 191 updates to the energy function C(X) in which the peak of the energy function C(X) further shifts to the right side in the figure, of the peak of the energy function C(X) shown by the line L212 of G52 in FIG. 5. Moreover, as shown by the line L213 of the graph G62, the distribution determination unit 191 updates to the energy function C(X) so as to be steeper (the foot thereof spreads to a lesser extent) than that in the case of the line L212 of the graph G52. This represents that the distribution determination unit 191 calculates the energy function C(X) on the basis of the plurality of sets illustrated in the graph G53 of FIG. 5 (combinations of a parameter value and a numerical value indicating the degree of the occurrence of the target event in the case of the parameter value).

The graph G63 shows an example of the output value of the model F(X) (that is, whether or not the target event occurs in the case of the parameter value) with respect to the value of the parameter X sampled by the condition acquisition unit 192 on the basis of the energy function C(X) shown in the graph G62. The horizontal axis of the graph G63 shows the value of parameter X, and the vertical axis shows the value of the model F(X). The line L221 shows the model F(X) that is the same as that in the case of the graph G43. Since the line L221 is the same line according to the same model as that in the case of the graph G43, the same reference symbol (L221) as that in the case of the graph G43 is used. The dots on the line L221 show an example of the output value of the model F(X) with respect to the value of the parameter X sampled by the condition acquisition unit 192 on the basis of the energy function C(X) of the line L211.

In the graph G53 of FIG. 5, the number of sampling points of the value of the parameter X at which a target event occurs was four. In contrast to this, since the peak of the energy function C(X) has shifted to the right side, in the graph G63, the values of the parameter X at which a target event occurs have increased to five.

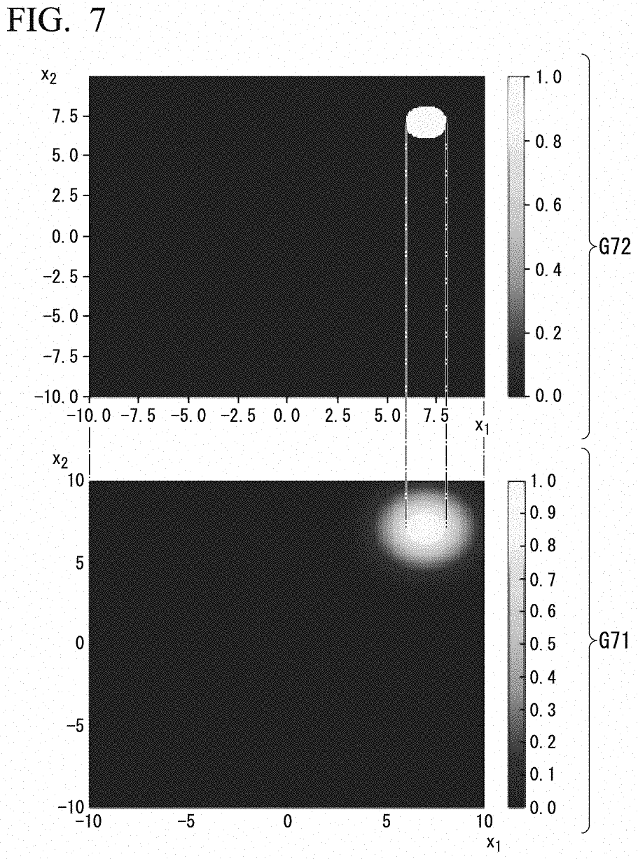

FIG. 7 is a diagram showing an example in which the distribution determination unit 191 has further updated the energy function from the setting shown in the graph G61 of FIG. 6. FIG. 7 shows two graphs, G71 and G72. Of these, the graph G71 shows an example of the energy function C(X) that has been updated from the setting (graph G61) shown in FIG. 6. The horizontal axis of the graph G71 shows the value of parameter x₁, and the vertical axis shows the value of parameter x₂. The graph G71 shows an example of a case where the value of the parameter X is represented by the two-dimensional axes of x₁ and x₂, and the value of the energy function C(X) is shown in brightness (black-white gradation).

In the sampling on the basis of the energy function C(X) of the graph G61 of FIG. 6, as one new value of the parameter X in which the target event occurs was detected on the right side in the graph G63 of FIG. 6, a new value of the parameter X in which the target event occurs is detected on the right side of the figure. Accordingly, the distribution determination unit 191 updates to the energy function C(X) in which the peak of the energy function C(X) has shifted to the right side in the figure, of the peak of the energy function C(X) shown in the graph G61 of FIG. 6. The distribution determination unit 191 particularly generates the energy function C(X) in which the foot corresponding to the peak of the energy function C(X) has moved to the right side in the figure and the function is steeper (the spread of the foot thereof is narrower), compared to the case of the graph G61 of FIG. 6.

The graph G72 shows an example of a model in a case where the value of the parameter X is represented by the two-dimensional axes of x₁ and x₂. In the energy function shown in the graph G71, in the model shown in the graph G72, the region of the parameter value where the target event occurs and the value at the boundary are large and the value of the energy function C(X) is small in the region of the parameter value where the target event does not occur.

In this manner, in the example of FIG. 7, the distribution determination unit 191 appropriately sets the energy function C(X). It is expected that the condition acquisition unit 192 samples the value of the parameter X on the basis of the energy function shown in the graph G71, and thereby the condition under which the target event occurs and the boundary condition become clear.

The method of updating the energy function C(X) described with reference to FIG. 4 to FIG. 7 is an example, and it is not limited to this method. As the method for the distribution determination unit 191 to update the energy function, there may be used a method in which the peak of the energy function C(X) is taken at or in the vicinity of the sampling point of the value of the parameter X where a target event occurs, and the foot from the peak does not spread into the region that includes the sampling points of the value of parameter X where no target event occurs too much.

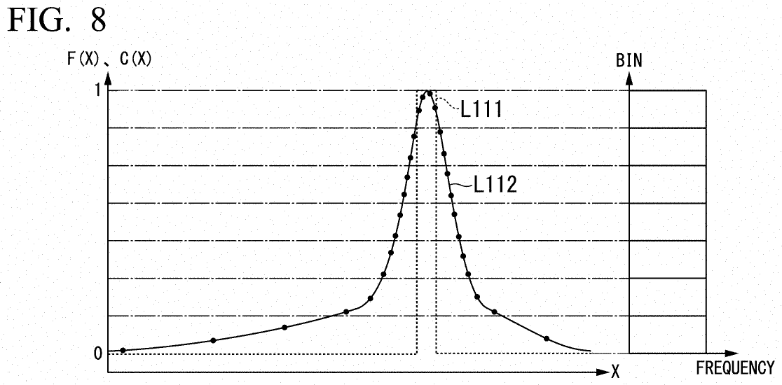

FIG. 8 is a diagram showing an example of sampling of the value of the parameter X performed on the basis of the energy function C(X) by the condition acquisition unit 192.

In addition to the graph of the energy function, FIG. 8 shows a result (frequency distribution, frequency distribution) obtained by executing the process of frequency analysis on the degree of occurrence of a target event shown by a plurality of sets. That is to say, the coefficient setting unit 193 of the condition acquisition unit 192 executes a process of frequency analysis on the value indicating the degree of the occurrence of the target event included in the plurality of sets, and as a result, the coefficient setting unit 193 calculates a bin related to the degree of the occurrence of the target event and the frequency within the bin.

The frequency analysis referred to here is to analyze the distribution of the magnitude of an analysis target value, and, specifically, is, for a divided bin of a range that can be taken by the value, to analyze the frequency at which the value is included in the bin. In the case of the coefficient setting unit 193, for a divided bin of a range that can be taken by an energy function value, the frequency at which the energy function value is included in the bin is analyzed.

Thus, the coefficient setting unit 193, for each divided bin of a range that can be taken by a numerical value indicating the degree of the occurrence of a target event, calculates the frequency at which the numerical value is included in the bin. The coefficient setting unit 193 corresponds to an example of a frequency calculation unit. The range that can be taken by a numerical value indicating the degree of the occurrence of a target event may be a value range of a numerical value that indicates the degree of the occurrence of the target event (therefore, a value range of the model F(X) or a value range of the energy function C(X)); however, it is not limited to this example.

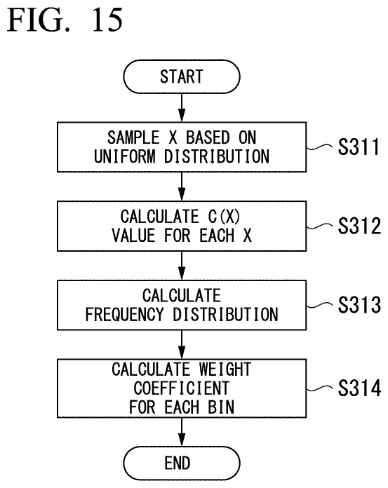

For example, the coefficient setting unit 193 may execute a frequency analysis process for all of the plurality of sets received until the process illustrated in Step S314 of FIG. 15 has started.

The horizontal axis of the energy function graph shown in FIG. 8 shows the value of parameter X, and the vertical axis shows the value of the energy function C(X) and the value of the model F(X) (that is, the value for whether or not a target event occurs in the case of a parameter value X).

As with the case of FIG. 2 and the case of FIG. 3, the line L111 shows the model F(X). The line L112 shows the energy function C(X). The dots on the line L112 show the output value of the energy function F(X) with respect to the parameter value sampled by the condition acquisition unit 192.

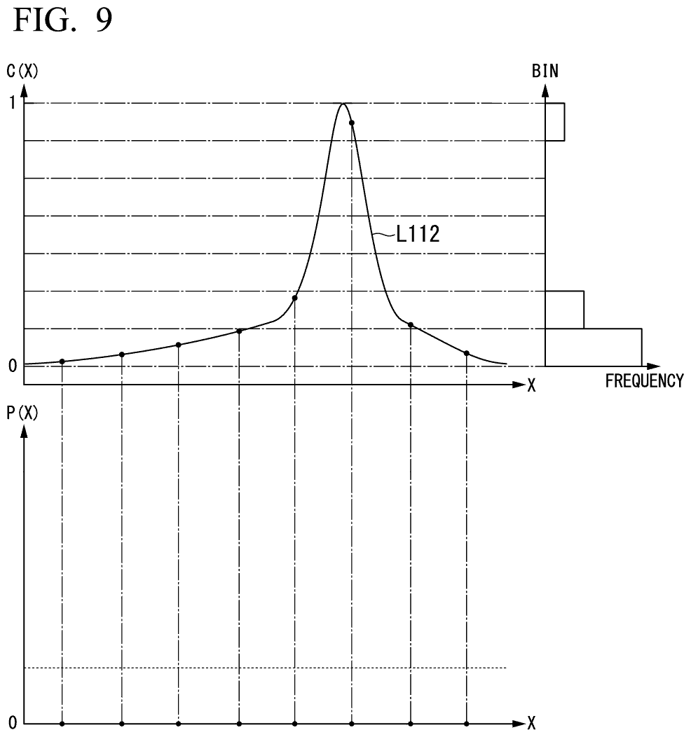

In the example of FIG. 8, four dots are included in each bin of the value of the energy function C(X). This indicates that the degree of the occurrence of the target event in the case of the parameter value generated by the condition acquisition unit 192 is the same in all of the bins related to the degree. Here is described a case where the energy function shown in FIG. 8 is generated on the basis of a plurality of sets input in one iterative process shown in FIG. 13 to FIG. 15 described later. In this case, it is shown that the same number of parameter values included in the plurality of sets were generated in each bin. Moreover, here is described a case where the energy function shown in FIG. 8 is generated on the basis of all of the sets received in the iterative process shown in FIG. 13 to FIG. 15. In this case, it is shown that the same number of parameter values are generated in each bin by the process, which is described later with reference to FIG. 9, for appropriately adjusting the weight coefficient value.

FIG. 9 is a diagram conceptually showing an example of weight coefficient values calculated by the coefficient setting unit 193. As mentioned above, the coefficient setting unit 193 performs frequency analysis to acquire a frequency distribution. The coefficient setting unit 193 adjusts the number of parameter values set in each bin by the sampling processing unit 194, using this frequency distribution.

In the example of FIG. 9, on the basis of the frequency (frequency) of the parameter value generated by the sampling processing unit 194, the coefficient setting unit 193 sets the weight coefficient value for each bin, so that the number of parameter values in the bin where the frequency is low and the number of parameter values in the bin where the frequency is high are the same. In other words, the coefficient setting unit 193 sets the weight coefficient value, so that the increase or decrease in the number of parameter values in the bin where the parameter value frequency is low increases more than the increase or decrease in the number of parameter values in the bin where the parameter value frequency is high.

Alternatively, the coefficient setting unit 193 may set the number of parameter values in the bin where the frequency is low greater than that in the bin where the frequency is high. That is to say, the coefficient setting unit 193 may set the weight coefficient value so that the sampling processing unit 194 calculates a larger number of parameter values in the bin where the frequency is low than that in the bin where the frequency is high.

The coefficient setting unit 193 may calculate the number of parameter values generated for each bin (or the weight coefficient value for each bin) on the basis of the frequency of the parameter values. In such a case, the coefficient setting unit 193 may, for example, compare the frequencies in the plurality of bins and determine the number of parameter values to be generated for a certain bin, on the basis of the comparison result. Alternatively, the coefficient setting unit 193 may, for example, by means of a process of calculating the reciprocal or the like of the frequency in a single bin, determine the number of parameter values to be generated for that single bin. The coefficient setting unit 193 need not always calculate the weight coefficient value for all bins, and may calculate the weight coefficient value for some of the bins only. For example, the coefficient setting unit 193 may not calculate the frequency for a bin where the frequency is extremely high as compared with other bins. The process of determining the weight coefficient value (or the number of parameter values) by the coefficient setting unit 193 is not limited to the process described above.

As described above, the coefficient setting unit 193 uses the frequencies mentioned above at least for some of the bins to set the weight coefficient value, so that the number of parameter values that are the calculation target numerical values (the numerical values indicating the degree of the occurrence of a target event) increases more for bins where the frequency is lower. The setting of the weight coefficient value by the coefficient setting unit 193 corresponds to an example of setting related to the number of parameter values. The coefficient setting unit 193 corresponds to an example of a number-related information setting unit.

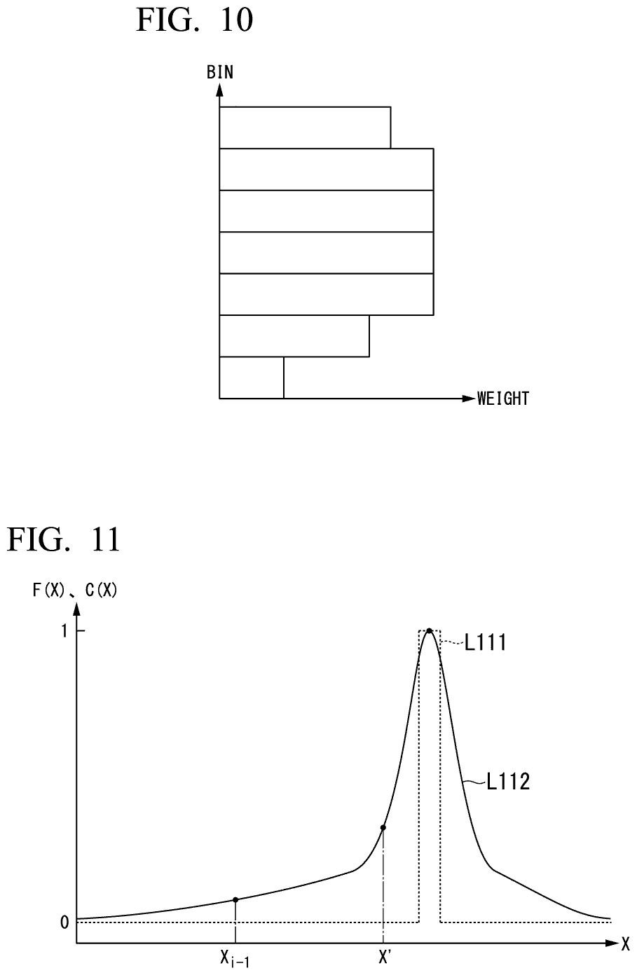

FIG. 10 is a diagram showing an example of weight coefficient values calculated by the coefficient setting unit 193. The vertical axis of FIG. 10 indicates the same bins as those in the case of the frequency distribution shown in FIG. 9, and the horizontal axis indicates the weight (the weight coefficient values or the number of parameter values generated (by the condition acquisition unit 192) for each bin). As illustrated in FIG. 9 and FIG. 10, for example, the coefficient setting unit 193 calculates the weight coefficient value for each bin so that the weight coefficient value (or the number of parameter values) becomes greater as the frequency (frequency) in the bin shown in FIG. 9 is lower.

The weight coefficient value calculated by the coefficient setting unit 193 for a bin Rⱼ (where j indicates the number of bins) is expressed as W(Rⱼ).

When calculating the parameter value in a bin the sampling processing unit 194 obtains the value of the energy function C(X) by applying the generated energy function C(X) to the value of a certain parameter X, and calculates the bin Rⱼ including the obtained value (the value of energy function C(X)). By repeating such processing, the sampling processing unit 194 generates parameter values by the amount corresponding to the weight coefficient value W (Rⱼ). The sampling processing unit 194 may select a parameter value from a database (not shown in the drawings) in which parameter values are stored preliminarily, or may calculate a parameter value in a predetermined range. In each example embodiment of the present invention, these two processes are collectively referred to as “sampling”.

Thus, the sampling processing unit 194 sets parameter values on the basis of the setting related to the number of parameter values indicated by the weight coefficient value set by the coefficient setting unit. The sampling processing unit 194 corresponds to an example of a parameter value setting execution unit.

For example, the coefficient setting unit 193 may calculate the weight coefficient value on the basis of Equation (2).

$$\begin{matrix}[ Equation 2 ] & \\ {W}_{j} = W ( {R}_{j} ) = \frac{{h}^{*}}{\vert {h}^{*} - {h}_{j} \vert} & ( 2 )\end{matrix}$$

In Equation (2), j is an identification number that identifies a bin of the frequency distribution. In Equation (2), it identifies any one bin which is a processing target for which the coefficient setting unit 193 calculates the weight coefficient value.

Rⱼ indicates the bin identified by j. hⱼ indicates the frequency in the bin Rⱼ (the number of samples included in the bin).

Wⱼ indicates the weight in the bin (bin Rⱼ) identified by j. W (Rⱼ) indicates the weight in the bin Therefore, as shown in Equation (2), “Wⱼ=W(Rⱼ)”.

h* indicates a positive integer constant for which a predetermined value is defined. The value of h* may be set, for example, to a value greater than the maximum value of the frequency assumed in the sampling performed by the coefficient setting unit 193, so that “h*−hⱼ>0” is established to avoid division with a divisor 0.

Alternatively, the coefficient setting unit 193 may simply calculate the reciprocal of a frequency as a weight coefficient value. In the case where the number of samples in a certain bin is i (i being a positive integer), the coefficient setting unit 193 may calculate the weight coefficient value as 1/i. For the bin where the number of samples is 0, the coefficient setting unit 193 may set the weight coefficient value so that a predetermined positive value (for example, a value of 1 or more) is added first and the reciprocal is calculated.

FIG. 11 is a diagram showing a first example of parameter values temporarily sampled by the sampling processing unit 194. The horizontal axis of the graph in FIG. 11 indicates the value of the parameter X, and the vertical axis indicates the value of the model F(X) and the value of the energy function C(X).

As with the case of FIG. 2, the line L111 shows an example of the model F(X) (that is, information indicating whether or not a target event occurs). The line L112 shows an example of the energy function C(X).

The sampling processing unit 194 temporarily samples the value of the parameter X, and determines whether or not to adopt the temporarily sampled parameter value as a sampling of the parameter value. As a criterion for the sampling processing unit 194 to adopt a temporary sampling as a sampling, a criterion that satisfies both of the following two conditions is used.

(a) As compared with the energy function value C(Xᵢ₋₁) with respect to the parameter value in previous sampling (i represents a positive integer indicating the number of sampling), the greater the energy function value C(X′) is with respect to the temporarily sampled parameter value X′, the more likely the temporarily sampled parameter value X′ is adopted as a sampling. The previous sampling referred to here is previous sampling (parameter value setting) performed within the process of the sampling processing unit 194 for calculating multiple parameter values using a weight coefficient value when the coefficient setting unit 193 performs the process of calculating the weight coefficient value once, as with the example of FIG. 14 described later. FIG. 11 shows an example of processing performed when the sampling processing unit 194 calculates the parameter value Xᵢ (here, i is an integer where i≥2). In such a case, the parameter value in the previous sampling is the parameter value Xᵢ₋₁.

Therefore, the sampling processing unit 194 obtains respective energy function values for and X′, using the energy function, and compares the magnitudes thereof.

Under this condition, the number of samplings can be increased at a location where the value of the energy function C(X) is large.

(b) In the sampling performed by the coefficient setting unit 193, the temporarily sampled parameter value X′ is more likely to be adopted in a bin where the number of samplings is lower (a bin where the weight coefficient value is greater).

Under this condition, as described with reference to FIG. 8, it is possible to equalize the frequency distribution of the number of sampling points of the value of the parameter X when a bin is set for the value of the energy function C(X).

For example, the coefficient setting unit 193 calculates a temporary sampling score (an evaluation value) r, using Equation (3).

$$\begin{matrix}[ Equation 3 ] & \\ r = \frac{C ( {X}^{′} ) \cdot W ( R ( C ( {X}^{′} ) ) )}{C ( {X}_{i - 1} ) \cdot W ( R ( C ( {X}_{i - 1} ) ) )} & ( 3 )\end{matrix}$$

In Equation (3), R(C(X)) indicates a bin that includes the energy function value C(X). Therefore, R(C(X′)) indicates a bin that includes the energy function value C(X′) with respect to the temporarily sampled parameter value X′. R(C(Xᵢ₋₁)) indicates a bin that includes the energy function value C(Xᵢ₋₁) with respect to the previous parameter value Xᵢ₋₁.

According to Equation (3), “C(X′)/C(X₁₋₁)” results in that the greater the energy function value C(X′) compared with the energy function value C(Xᵢ₋₁), the greater the value of score r becomes. Moreover, the numerator “W(R(C(X′)))” results in that the greater the weight coefficient value W(R(C(X′))), the greater the value of score r becomes.

On the basis of Equation (4), the coefficient setting unit 193 determines whether or not to adopt the temporarily sampled parameter value X′ as a sampling.

$$\begin{matrix}[ Equation 4 ] & \\ \{ \begin{matrix}r \geq {r}_{0} -> Accept \\ r < {r}_{0} -> Reject\end{matrix} & ( 4 )\end{matrix}$$

In Equation (4), Accept indicates that the temporarily sampled parameter value X′ is adopted as a sampling. Reject indicates that the temporarily sampled parameter value X′ is not adopted (rejected) as a sampling.

r₀ is a threshold value used by the coefficient setting unit 193 to perform determination with Equation (4), and is expressed as in Equation (5).

$$\begin{matrix}[ Equation 5 ] & \\ {r}_{0} = Uniform [ 0 , 1 ] & ( 5 )\end{matrix}$$

In Equation (5), Uniform [0,1] indicates that values are extracted from the bin of [0,1] with an even probability distribution. Therefore, r₀ is a random number where 0≤r₀≤1.

The coefficient setting unit 193 sets the value of r₀ each time the determination with Equation (4) is performed.

That is to say, the coefficient setting unit 193 executes the processing described above while making reference to Equation (3) to Equation (5), and thereby, on the basis of whether or not the energy function value C(X) (that is, the value indicating the degree of the occurrence of a target related to a parameter value) satisfies the criterion, determines whether or not to generate the parameter value (whether or not to adopt the temporary parameter value). In the above example, the criterion to determine whether or not to generate the parameter value may be a value different from the energy function value related to the previous parameter value (the numerical value indicating the degree of the occurrence of the target related to the parameter value). For example, this criterion may be a value that increases as the number of iterations increases. This criterion may be a value that increases with every multiple iteration. This criterion may be the average of the energy functions related to the parameter values calculated up to the (I−1)-th iteration at the I-th iteration (where I is a natural number of 2 or more). That is to say, the criterion is not limited to the example described above.

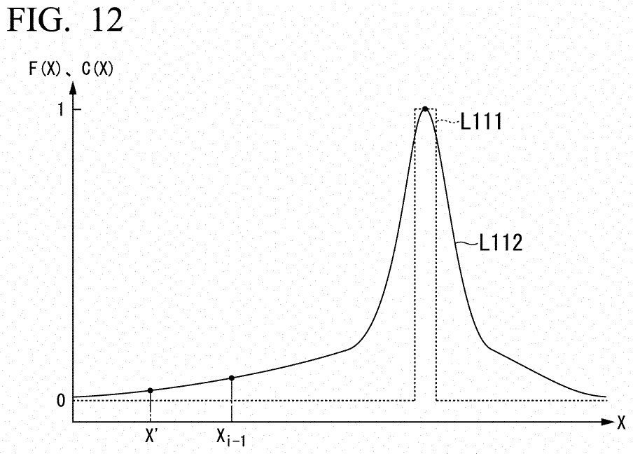

FIG. 12 is a diagram showing a second example of parameter values temporarily sampled by the sampling processing unit 194. The horizontal axis of the graph in FIG. 12 indicates the value of the parameter X, and the vertical axis indicates the value of the model F(X) and the value of the energy function C(X).

As with the case of FIG. 2, the line L111 shows an example of the model F(X). The line L112 shows an example of the energy function C(X).

As with the case of FIG. 11, FIG. 12 also shows an example of processing performed when the sampling processing unit 194 calculates the parameter value Xᵢ (here, i is an integer where i≥2), and the parameter value in the previous sampling is the parameter value Xᵢ₋₁.

In the example of FIG. 11, the energy function value C(X′) is greater than the energy function value C(Xᵢ₋₁). In contrast to this, in the example of FIG. 12, the energy function value C(X′) is smaller than the energy function value C(Xᵢ₋₁). Therefore, in terms of (a) among the conditions described above, the probability of the temporarily sampled parameter value X′ being adopted as a sampling is lower in the case of FIG. 12 than in the case of FIG. 11.

The method by which the condition acquisition unit 192 samples parameter values with a distribution according to the energy function C(X) is not limited to the method that has been described with reference to FIG. 9 to FIG. 12. For example, the distribution determination unit 191 may calculate the energy function C(X) capable of acquiring a reciprocal function, and the condition acquisition unit 192 may determine the parameter value according to the energy function value, using the reciprocal function of the energy function.

Next, the operation of the search device 100 will be described with reference to FIG. 13 to FIG. 15.

FIG. 13 is a flowchart showing an example of a processing procedure in which the search device 100 searches for an occurrence condition of a target event.

In the process of FIG. 13, the distribution determination unit 191 performs initial setting on the energy function C(X) (Step S111). In the case where there is no set that combines a parameter value and a numerical value indicating the degree of the occurrence of a target event in the case of the parameter value (or information indicating whether or not a target event occurs), the distribution determination unit 191 calculates, for example, an energy function that yields a constant value with respect to the parameter value. In the case where a plurality of the sets mentioned above exist, the distribution determination unit 191 calculates the relationship between the parameter value and the numerical value in the plurality of sets. For convenience of description, the description of the subsequent processing assumes that a plurality of sets exist.

As will be described later with reference to FIG. 15, the condition acquisition unit 192 performs frequency analysis on the numerical value in the plurality of sets to thereby calculate the frequency (frequency) of the parameter value for each bin of the numerical value (the numerical value indicating the degree of the occurrence of the target event) (see Step S313 of FIG. 15).

Then, the coefficient setting unit 193 of the condition acquisition unit 192 calculates the weight coefficient value for adjusting the number of parameter values for each bin on the basis of the obtained frequency (see Step S314 of FIG. 15).

For example, the coefficient setting unit 193 calculates the number of parameters to be calculated for at least some bins on the basis of the frequency calculated by the condition acquisition unit 192. As described above, the coefficient setting unit 193 sets the weight coefficient value for each bin, so that the number of parameter values in the bin where the frequency is low and the number of parameter values in the bin where the frequency is high match. In other words, the coefficient setting unit 193 sets the weight coefficient value, so that the amount of increase in the number of parameter values in the bin where the parameter value frequency is low increases more than the amount of increase in the number of parameter values in the bin where the parameter value frequency is high. The coefficient setting unit 193 may calculate the number of parameter values (weight coefficient values) according to the processing described with reference to Equation (2) to Equation (5) and so forth.

The sampling processing unit 194 of the condition acquisition unit 192 uses the energy function calculated by the distribution determination unit 191 (that is, the relationship between a parameter value and a numerical value indicating the degree of the occurrence of a target event in the case of the parameter value), to calculate parameter values the number of which accords with the weight coefficient value (Step S112).

Then, the condition acquisition unit 192 inputs each of the sampled parameter values, for example, into the model F(X), to thereby acquire the numerical value that indicates the degree of the occurrence of the target event (or information that indicates whether or not the target event occurs) (Step S113). The condition acquisition unit 192 generates sets that each combine a parameter value and a numerical value indicating the degree of the occurrence of the target event in the case of that parameter value. The condition acquisition unit 192 generates the sets the number of which equals to the number of generated parameter values (that is, the number of samplings).

Through the processing described above, the distribution determination unit 191 calculates (learns) a model that surrogates the model F(X). Model F(X) represents, for example, a process of simulation according to a simulation model on the basis of parameter values. Alternatively, the model F(X) may represent a process of identifying whether or not a target event occurs, by observing the situation indicated by parameter values.

On the basis of the plurality of sets generated by the condition acquisition unit 192, the distribution determination unit 191 calculates the relationship between the parameter value and the numerical value in each of the plurality of sets. That is to say, the distribution determination unit 191 updates the energy function C(X) on the basis of the plurality of sets generated by the condition acquisition unit 192 (Step S114).

Then, the control unit 190 determines whether or not the end condition of the process of FIG. 13 is satisfied (Step S115).

Various conditions can be used as the end condition in Step S115. For example, the control unit 190 may determine the end condition as being satisfied when the processing time of the search device 100 exceeds a predetermined amount of time. Alternatively, the control unit 190 may determine the end condition as being satisfied when the value of the parameter X becomes greater than or equal to the number of samplings.

If the control unit 190 determines the end condition as not being satisfied (Step S115: NO), the process returns to Step S112.

On the other hand, if the control unit 190 determines the end condition as being satisfied (Step S115: YES), the search device 100 outputs the search result (Step S116). For example, every time a parameter value (X where F(X)=1) where occurrence of a target event is detected in Step S113, the event occurrence parameter value extraction unit 195 of the condition acquisition unit 192 stores the parameter value in the storage unit 180. Then, in Step S116, the condition acquisition unit 192 reads out the parameter value stored in the storage unit 180, and displays the read parameter value on the display unit 120.

After Step S116, the search device 100 ends the process of FIG. 13.

FIG. 14 is a flowchart showing an example of a processing procedure in which the condition acquisition unit 192 samples the value of the parameter X. The condition acquisition unit 192 performs the process of FIG. 14 in Step S112 of FIG. 13.

In the process of FIG. 14, the coefficient setting unit 193 calculates the weight coefficient value W(Rⱼ) for each bin on the basis of the result of frequency analysis (Step S211). Here, j is an integer that identifies a bin, and M is the number of bins where 1≤j≤M.

Next, the sampling processing unit 194 randomly samples the parameter value X₁ (Step S212). The parameter value X₁ sampled in Step S212 is adopted as a sampling rather than a temporary sampling.

The sampling processing unit 194 inputs the parameter value X₁ into the energy function C(X) to calculate the energy function value C(X₁) (Step S213).

Then, the sampling processing unit 194 acquires the weight coefficient value W(R(C(X₁))) corresponding to a bin R(C(X₁)) that includes the energy function value C(X₁) (Step S214).

Moreover, the sampling processing unit 194 sets the value of a counter i to 2 (Step S215). The counter i is used as an index that indicates the number of samplings in the process of FIG. 14. That is to say, when the value of i is 2, it means that the second parameter value is calculated in the processes shown in Step S216 to Step S224.

Next, the sampling processing unit 194 randomly performs temporary sampling of the parameter value X′ (Step S216).

The sampling processing unit 194 inputs the parameter value X′ into the energy function C(X) to calculate the energy function value C(X′) (Step S217).

Then, the sampling processing unit 194 obtains a bin (a bin that includes C(X′)) R(C(X′)) corresponding to the energy function value C(X′), and acquires the weight coefficient value W(R(C(X′))) related to the obtained bin R(C(X′)) (Step S218).

Next, the sampling processing unit 194 calculates the score r of the temporary sampling, on the basis of Equation (3).

Moreover, the sampling processing unit 194 sets the threshold value r₀ on the basis of Equation 5 (Step S220).

Then, the sampling processing unit 194 determines whether or not the value of the score r equals to the threshold value r₀ or more (Step S221).

If the sampling processing unit 194 determines the value of the score r as being less than the threshold value r₀ (Step S221: NO), the process returns to Step S216.

On the other hand, if the sampling processing unit 194 determines the value of the score r as being equal to or greater than the threshold value r₀ (Step S221: YES), the sampling processing unit 194 adopts the temporarily sampled parameter value X′ as a parameter value Xᵢ (Step S222). Specifically, the sampling processing unit 194 sets the parameter value Xᵢ to X′, and acquires the bin R(C(Xᵢ)) including “energy function value C(Xᵢ)=C(X′), C(Xᵢ)”, and the weight coefficient value W(R(C(Xᵢ))).

In this way, the sampling processing unit 194 identifies which bin (Rⱼ) includes the energy function value C(Xᵢ) (where i≥2) calculated by the distribution determination unit 191. The sampling processing unit 194 determines whether or not the parameter values for the weight coefficient value W(Rⱼ) related to the identified bin (Rⱼ) (or for the number) have been calculated. If the calculated number does not satisfy the condition related to the weight coefficient value W(Rⱼ), the sampling processing unit 194 adopts the calculated parameter values as samplings. If the calculated number satisfies the condition related to the weight coefficient value W(Rⱼ), the sampling processing unit 194 does not adopt the calculated parameter values as samplings. In this case, the condition related to the weight coefficient value is, for example, such that the number of calculated parameter values exceeds the number calculated by the coefficient setting unit 193. In the case where the condition related to the weight coefficient value is, for example, a condition such that the number of calculated parameter values is equal to or less than the number calculated by the coefficient setting unit 193, the sampling processing unit 194 may execute the process of adopting the calculated parameter values as samplings when the condition is satisfied. The process performed in the sampling processing unit 194 is not limited to the above example.

Next, the sampling processing unit 194 determines whether or not the number of samplings has reached an upper limit (Step S223). Specifically, the sampling processing unit 194 determines whether or not the value of the counter i is equal to or greater than a predetermined threshold value iₘₐₓ.

If the sampling processing unit 194 determines the number of samplings as having not reached the upper limit (Step S223: NO), the sampling processing unit 194 increases the value of the counter i by 1 (Step S224).

After Step S224, the process returns to Step S216.

On the other hand, if the sampling processing unit 194 determines the number of samplings as having reached the upper limit (Step S223: YES), the condition acquisition unit 192 ends the process of FIG. 14.

FIG. 15 is a flowchart showing an example of a processing procedure in which the coefficient setting unit 193 calculates a weight coefficient value W(R(C(X))) for each bin R(C(X)) of the value of the energy function C(X). The coefficient setting unit 193 performs the process of FIG. 15 in Step S211 of FIG. 14.

In the process of FIG. 15, the coefficient setting unit 193 samples the value of parameter X on the basis of a uniform distribution (Step S311).

Next, the coefficient setting unit 193 calculates the value of the energy function C(X) for each sampled parameter value (Step S312).

Then, the coefficient setting unit 193 calculates the frequency distribution of the number of samplings for each frequency of the value of the energy function C(X) (Step S313).

The coefficient setting unit 193 calculates the value of the weight coefficient value W(C(R(X))) on the basis of Equation (2) for each bin of the frequency distribution (Step S314).

After Step S314, the coefficient setting unit 193 ends the process of FIG. 15.

The computation of the model F(X) may be performed by a device different from the search device.

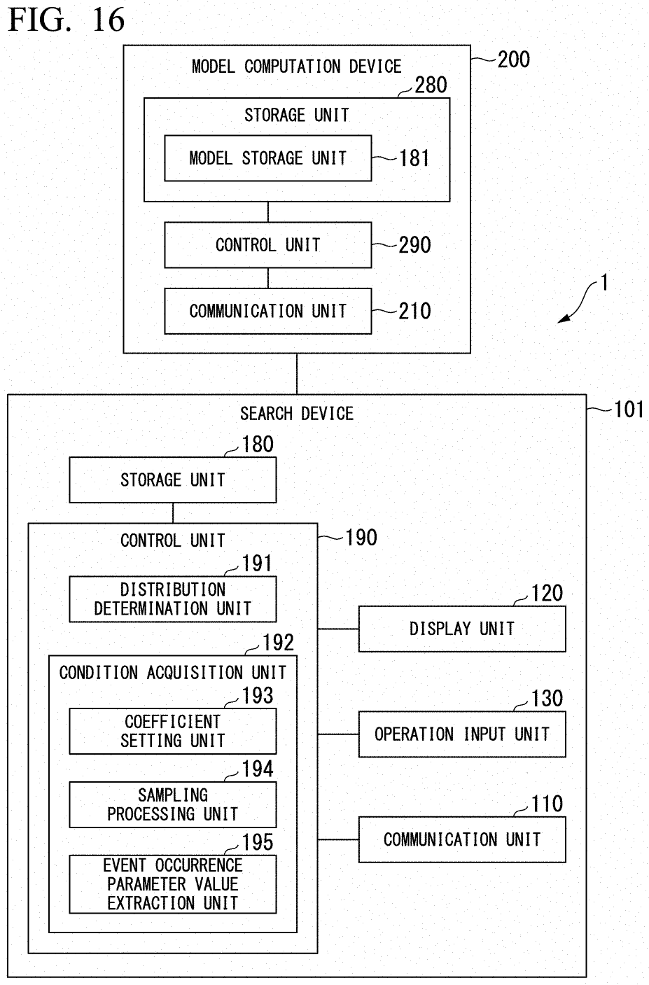

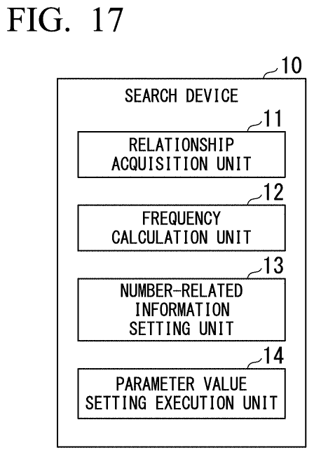

FIG. 16 is a diagram showing a configuration example of a search system in a case where a device different from the search device performs the computation of the model F(X).

In the configuration shown in FIG. 16, a search system 1 includes a search device 101 and a model computation device 200. The search device 101 includes a communication unit 110, a display unit 120, an operation input unit 130, a storage unit 180, and a control unit 190. The control unit 190 includes a distribution determination unit 191 and a condition acquisition unit 192. The condition acquisition unit 192 includes a coefficient setting unit 193, a sampling processing unit 194, and an event occurrence parameter value extraction unit 195. The model computation device 200 includes a communication unit 210, a storage unit 280, and a control unit 290. The storage unit 280 includes a model storage unit 181.

Of the units shown in FIG. 16, ones corresponding to those in FIG. 1 and having the same functions are given the same reference symbols (120, 130, 180, 181, 190, 191, 192, 193, 194, and 195), and descriptions thereof are omitted.

In the search system 1, the model computation device 200 provided outside the search device 101 performs computation of the model F(X). Therefore, not the storage unit 180 on the search device 101 side, but the storage unit 280 on the model storage unit 200 side includes the model storage unit 181.

Moreover, the search device 101 includes the communication unit 110. The communication unit 110 communicates with the communication unit 210 on the model computation device 200 side. In particular, the communication unit 110 transmits a request for the computation of the model F(X) to the communication unit 210, and receives a response of the computation result (the value of the model F(X)).

Therefore, the control unit 190 need not perform the computation of the model F(X).

Apart from that, the search device 101 is similar to the search device 100 (FIG. 1).

The model computation device 200 performs the computation of the model F(X). For example, the model computation device 200 may execute simulated calculation of the degree of the occurrence of a target event (this may be whether or not the target event occurs) under the condition (situation) indicated by the parameter value X.

The model computation device 200 is configured, using a computer such as a personal computer and a workstation.

The communication unit 210 communicates with the communication unit 110 on the search device 101 side. As mentioned above, the communication unit 210 receives a request for the computation of the model F(X) from the communication unit 110, and transmits a response of the computation result (the value of the model F(X)) to the communication unit 110.

The storage unit 280 stores various types of data. In particular, the model storage unit 181 of the storage unit 280 stores the model F(X) as described above. The storage unit 280 is configured using a storage device included in the model computation device 200.

The control unit 290 controls each unit of the model computation device 200 and executes various processes. In particular, the model computation device 200 applies, to the model F(X) stored in the model storage unit 181, the parameter value indicated in the request received by the communication unit 210, and acquires the computation result of the degree of the occurrence of the target event (this may be whether or not the target event occurs). The control unit 290 controls the communication unit 210 to transmit the computation result as a response to the communication unit 110.

The control unit 290 is configured such that a CPU included in the model computation device 200 reads out a program from the storage unit 280 and executes the program.

Thus, since the model computation device 200 performs the computation of the model F(X), the search device 101 need not perform the computation of the model F(X). In this respect, the load on the search device 101 is low.

As described above, for a plurality of sets each combining a parameter value and a numerical value indicating the degree of the occurrence of a target event in the case of the parameter value, the distribution determination unit 191 calculates the relationship between the parameter value and the numerical value. The coefficient setting unit 193, for each divided bin of a range that can be taken by the numerical value, calculates the frequency at which the numerical value is included in the bin. Moreover, using the frequency, for at least some of the bins, the coefficient setting unit 193 performs a setting relating to the number of parameter values such that the lower the frequency of a bin, the greater the number of parameter values serving as calculation targets of the numerical value. The sampling processing unit 194 sets parameter values on the basis of the setting related to the number of parameter values.

According to the search device 100, by setting the parameter value on the basis of the relationship (such as an energy function) between a parameter value and a numerical value indicating the degree of the occurrence of a target event in the case of the parameter value, it is possible, as described above, to set a comparatively large number of parameters within and around an area where the target event occurs, and it is possible to efficiently search for the situation where the target event occurs.

Thus, according to the search device 100, it is possible to efficiently search for a situation where a target event occurs even when the information that serves as a key to the search is not obtained in advance.

Moreover, the distribution determination unit 191 calculates the degree to which a target event occurs.

Accordingly, the distribution determination unit 191 can calculate the above relationship, using the calculated degree of the target event occurrence.

Furthermore, the distribution determination unit 191 calculates the degree of the target event occurrence with three or more values or in a continuous manner as in the energy function described above, so that a foot can be provided for the distribution peak of the parameter value setting by the sampling processing unit 194. In this respect, detection of the boundary of the condition under which the target event occurs becomes easy.

Moreover, the coefficient setting unit 193 obtains a difference between the frequency at which the numerical value is included in the bin and a desired frequency, and performs setting related to the number of the parameter values according to the obtained difference (for example, settings of weight coefficient value).

The sampling processing unit 194 sets the parameter values on the basis of this setting, so that it is possible, as described above, to set a comparatively large number of parameters within and around an area where the target event occurs, and it is possible to efficiently search for the situation where the target event occurs.

Thus, according to the search device 100, it is possible to efficiently search for a situation where a target event occurs even when the information that serves as a key to the search is not obtained in advance.

Moreover, the sampling processing unit 194 temporarily sets the parameter value, and determines whether or not to adopt the setting of the parameter value on the basis of whether or not the numerical value related to the parameter value calculated using the relationship between the parameter value and the numerical value (the numerical value indicating the degree of the occurrence of the target event in the case of the parameter value) satisfies the criterion.

As a result, the sampling processing unit 194 determines whether or not to adopt the temporarily set parameter value, so that temporary setting of the parameter value, such as randomly setting the parameter value, can be performed relatively easily. In this respect, the load on the sampling processing unit 194 becomes relatively low.

Moreover, the coefficient setting unit 193, for each divided bin of a range that can be taken by a numerical value (a numerical value indicating the degree of the occurrence of a target event in the case of the parameter value), calculates a coefficient value (weight coefficient value) for adjusting the number of parameter values in the bin, on the basis of the frequency at which the numerical value is included in the bin. The sampling processing unit 194 sets parameter values on the basis of the coefficient value calculated by the coefficient setting unit 193.

As a result, the sampling processing unit 194 can set a comparatively large number of parameters within and around an area where a target event occurs, and the search device 100 can efficiently search for the situation where the target event occurs.

Thus, according to the search device 100, it is possible to efficiently search for a situation where a target event occurs even when the information that serves as a key to the search is not obtained in advance.

Moreover, the coefficient setting unit 193 calculates the coefficient value according to the reciprocal of the frequency related to a bin (a divided bin of a range that can be taken by a numerical value (a numerical value indicating the degree of the occurrence of the target event in the case of the parameter value)). The magnitude of the coefficient value indicates the degree of the number of parameter values set by the sampling processing unit 194 for the bin.

As a result, the coefficient setting unit 193 can calculate the coefficient value by a comparatively simple calculation such as calculating the reciprocal of the frequency (frequency). In this respect, the load on the coefficient setting unit 193 becomes relatively low.

Next, a configuration example of an example embodiment of the present invention will be described, with reference to FIG. 17.

FIG. 17 is a diagram showing an example of a configuration of an event occurrence search device according to the example embodiment. In the configuration shown in FIG. 17, the search device 10 includes a relationship calculation unit 11, a frequency calculation unit 12, a number-related information setting unit 13, and a parameter value setting execution unit 14.

With this configuration, for a plurality of sets each combining a parameter value and a numerical value indicating the degree of the occurrence of a target event in the case of the parameter value, the relationship calculation unit 11 calculates the relationship between the parameter value and the numerical value. The frequency calculation unit 12, for each divided bin of a range that can be taken by a numerical value (a numerical value indicating the degree of the occurrence of a target event), calculates the frequency at which the numerical value is included in the bin. Using the frequency, for at least some of the bins, the number-related information setting unit 13 configures a setting relating to the number of parameter values such that the lower the frequency of a bin, the greater the number of parameter values serving as calculation targets of the numerical value. The parameter value setting execution unit 14 sets parameter values on the basis of the setting related to the number of parameter values.

According to the search device 10, by setting the parameter value on the basis of the relationship (such as an energy function) between a parameter value and a numerical value indicating the degree of the occurrence of a target event in the case of the parameter value, it is possible, as described above, to set a comparatively large number of parameters within and around an area where the target event occurs, and it is possible to efficiently search for the situation where the target event occurs.

Thus, according to the search device 10, it is possible to efficiently search for a situation where a target event occurs even when the information that serves as a key to the search is not obtained in advance.

Furthermore, the search device 10 may control operations in, for example, an identification device (such as a high throughput screening (HTS) device) that identifies a compound that specifically binds to a certain protein. Such an identification device operates according to the information output by the search device 10, and can efficiently identify the compound that specifically binds to the certain protein by experimenting with only a small number of compounds among millions of compounds, for example. Alternatively, the identification device 10 may control operations of an inspection device that performs a non-destructive inspection, for example. By operating according to the information output by the search device 10, such an inspection device can, at low processing cost, detect a defect in a series of products produced in a situation where the defect occurs without analyzing the products, for example. The device controlled by the search device 10 is not limited to the above examples.

Note that a program for executing all or part of the processes performed by the control unit 190 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to the embodiments and may include designs and so forth that do not depart from the scope of the present invention.

This application is based upon and claims the benefit of priority from Japanese patent application No. 2019-010663, filed Jan. 24, 2019, the disclosure of which is incorporated herein in its entirety by reference.

### INDUSTRIAL APPLICABILITY

The present invention may be applied to a search device, a search system, a search method, and a recording medium.

### REFERENCE SYMBOLS

1 Search system
10, 100 Search device
11 Relationship acquisition unit (relationship acquisition means)
12 Frequency calculation unit (frequency calculation means)
13 Number-related information setting unit (number setting means)
14 Parameter value setting execution unit (parameter setting means)
110, 210 Communication unit (communication means)
120 Display unit (display means)
130 Operation input unit (operation input means)
180, 280 Storage unit (storage means)
181 Model storage unit (model storage means)
190, 290 Control unit (control means)
191 Distribution determination unit (distribution determination means)
192 Condition acquisition unit (condition acquisition means)
193 Coefficient setting unit (coefficient setting means)
194 Sampling processing unit (sampling processing means)
195 Event occurrence parameter value extraction unit (event occurrence parameter value extraction means)
200 Model computation device

1. A search device comprising:
at least one memory configured to store instructions; and
at least one processor configured to execute the instructions to:
calculate a relationship by using a plurality of sets, each set including a parameter value and a numerical value indicating a degree of occurrence of a target event in a case of the parameter value, the relationship being a relationship between the parameter value and the numerical value;
calculate, for a plurality of bins obtained by dividing up a range range in which there is a possibility of the numerical value being included, a frequency at which the numerical value is included in a bin;
perform, for at least some bins of the plurality of bins, a setting relating to a number of the parameter value such that the lower the frequency of the bin, the greater a number of the parameter value serving as calculation subjects of the numerical value, by using the frequency; and
set parameter values by the set number.

2. The search device according to claim 1, wherein the at least one processor is configured to execute the instructions to calculate the degree of the occurrence of the target event.

3. The search device according to claim 1, wherein the at least one processor is configured to execute the instructions to obtain a difference between the frequency at which the numerical value is included in the bin and a desired frequency, and perform the setting relating to the number of the parameter value according to the obtained difference.

4. The search device according to claim 1, wherein the at least one processor is configured to execute the instructions to temporarily set the parameter value, and determine whether or not to adopt a setting of the parameter value based on whether or not the numerical value related to the parameter value calculated using the relationship satisfies a criterion.

5. The search device according to claim 1,
wherein the at least one processor is configured to execute the instructions to calculate a coefficient value for adjusting the number of the parameter values in the bin, based on the frequency, and
setting the parameter values comprises setting the parameter values based on the calculated coefficient value.

6. The search device according to claim 5,
wherein the at least one processor is configured to execute the instructions to calculate the coefficient value according to reciprocal of the frequency, with respect to the bin, and
magnitude of the coefficient value indicates a degree of largeness of a number of parameter values that are to be set for the bin.

7. The search device according to claim 1, comprising
wherein the at least one processor is configured to execute the instructions to obtain the relationship that fits the plurality of sets.

8. A search system comprising:
the search device according to claim 1; and
a device that comprises:
at least one memory configured to store second instructions; and
at least one processor configured to execute the second instructions to calculate a numerical value indicating a degree of occurrence of the target event corresponding to an input parameter value.

9. A search method executed by a computer, comprising:
calculating a relationship by using a plurality of sets, each set including a parameter value and a numerical value indicating a degree of occurrence of a target event in a case of the parameter value, the relationship being a relationship between the parameter value and the numerical value;
calculating, for a plurality of bins obtained by dividing up a range in which there is a possibility of the numerical value being included, a frequency at which the numerical value is included in a bin;
performing, for at least some bins of the plurality of bins, a setting relating to a number of the parameter value such that the lower the frequency of the bin, the greater a number of the parameter value serving as calculation subjects of the numerical value, by using the frequency; and
setting parameter values by the set number.

10. A non-transitory recording medium that stores a search program that causes a computer to execute:
calculating a relationship by using a plurality of sets, each set including a parameter value and a numerical value indicating a degree of occurrence of a target event in a case of the parameter value, the relationship being a relationship between the parameter value and the numerical value;
calculating, for a plurality of bins obtained by dividing up a range in which there is a possibility of the numerical value being included, a frequency at which the numerical value is included in a bin;
performing, for at least some bins of the plurality of bins, a setting relating to a number of the parameter value such that the lower the frequency of the bin, the greater a number of the parameter value serving as calculation subjects of the numerical value, by using the frequency; and
setting parameter values by the set number.
